(19) United States
(12) Patent Application Publication
(10) Pub. No.: US 2009/0167527 A1
(43) Pub. Date: Jul. 2, 2009

(54) VIDEO MONITORING SYSTEM AND METHOD

(75) Inventors: CHI-CHIH WANG, Tu-Cheng (TW); QUAN-ZHONG ZHANG, Shenzhen City, Guangdong Province (CN); FEI HUO, Shenzhen City, Guangdong Province (CN); JIA-YUAN LI, Shenzhen City, Guangdong Province (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/247,204

(22) Filed: Oct. 7, 2008

(30) Foreign Application Priority Data
Dec. 28, 2007 (CN) 200710203506.2

(51) Int. Cl. G08B 21/00

(52) U.S. Cl. 340/540; 348/61

(57) ABSTRACT

A video monitoring method is provided. The method includes capturing video data via a video capturing device, and sending the video data to a video server, generating a first parameter for controlling the video data for storing in a designated network video recorder (NVR) and a second parameter for controlling the video data to display on a designated monitor. The method further includes storing the video data in a storage system that is connected with the video server, sending the video data to the designated NVR for storing according to the first parameter, reading the video data from the designated NVR and displaying one video picture based upon the video data on the designated monitor according to the second parameter.

### BACKGROUND

1. Field of the Invention

Embodiments of the present disclosure relate to the field of monitoring technology, and more particularly to a video monitoring system and method.

2. Description of Related Art

Video monitoring technology is known in the art. A usual video monitoring method typically uses a monitoring device to capture video data from a local monitoring sub-system via a network. After the video data is captured, the monitoring device typically stores the video data in a storage system of the local monitoring sub-system or stores the video data in a fixed disk of the monitoring device. Such methods can easily loss the video data or fail to record the video data when any hardware of the monitoring device or the network has a fault. The methods also cannot detect the hardware in the fault.

Therefore, what is needed is a video monitoring system and method that can amend the aforementioned problems so as to ensure the safety of the video data.

### SUMMARY

A video monitoring method is provided. The video monitoring method includes: capturing video data via a video capturing device, and sending the video data to a video server; generating a first parameter for controlling the video data for storing in a designated network video recorder (NVR), and a second parameter for controlling the video data to display on a designated monitor; storing the video data in a storage system that is connected with the video server; sending the video data to the designated NVR for storing according to the first parameter; and reading the video data from the designated NVR and displaying one video picture based upon the video data on the designated monitor according to the second parameter.

Other advantages and novel features will become more apparent from the following detailed description certain embodiments of the present disclosure when taken in conjunction with the accompanying drawings.

### BRIEF DESCRIPTION OF THE DRAWINGS

FIG. 1 is a block diagram of one embodiment of a video monitoring system;

FIG. 2 is a schematic diagram of one embodiment of the video monitoring system of FIG. 1 in detail;

FIG. 3 is a signal flowchart of one embodiment of the video data of FIG. 2;

FIG. 4 is a block diagram of one embodiment of a video management computer of FIG. 2; and

FIG. 5 is a flowchart of one embodiment of a video monitoring method.

### DETAILED DESCRIPTION OF CERTAIN INVENTIVE EMBODIMENTS

The components in the drawings are not necessarily drawn to scale, the emphasis instead being placed upon clearly illustrating the principles of at least one embodiment. In the drawings, like reference numerals designate corresponding parts throughout the various views.

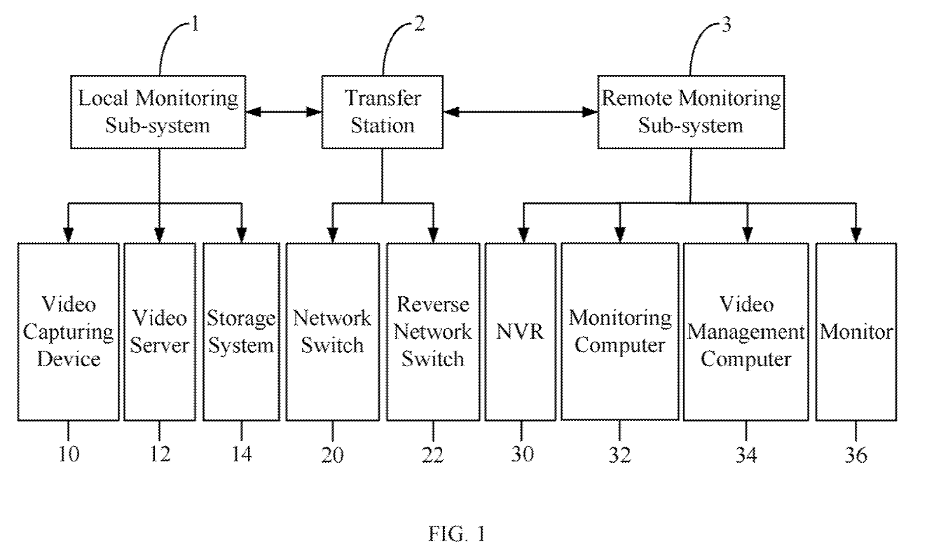

FIG. 1 is a block diagram of one embodiment of a video monitoring system for storing video data in two places synchronically and monitoring the video data timely. In the embodiment, the video monitoring system may include three sub-systems: a local monitoring sub-system 1, a transfer station 2, and a remote monitoring sub-system 3.

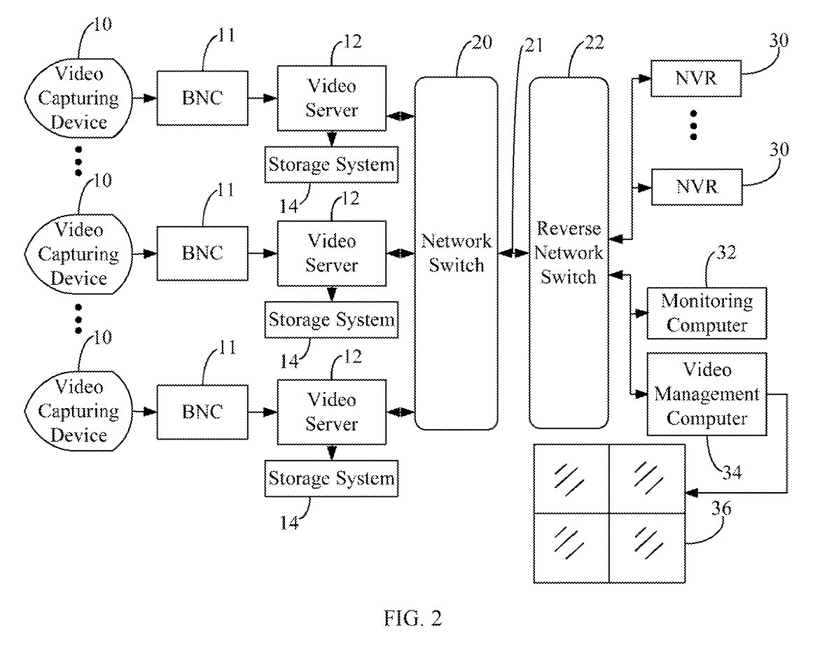

The local monitoring sub-system 1 may include at least one video capturing device 10 (only one shown in FIG. 1) for capturing video data from the local monitoring sub-system 1, at least one video server 12 (only one shown in FIG. 1) and at least one storage system 14 (only one shown in FIG. 1). The transfer station 2 may include a network switch 20, and a reverse network switch 22 connected with the network switch 20 (see in FIG. 2). The remote monitoring sub-system 3 may include at least one network video recorder (NVR) 30 (only one shown in FIG. 1), a monitoring computer 32, a video management computer 34, and at least one monitor 36 (only one shown in FIG. 1) that is connected with the video management computer 34. Using the video monitoring system, captured video data can be stored in two places simultaneously, such as the at least one storage system 14 of the local monitoring sub-system 1 and the at least one NVR 30 the remote monitoring sub-system 3.

FIG. 2 is a schematic diagram of one embodiment of the video monitoring system of FIG. 1 in detail communicating with three of the video capturing devices 10. Each of the video capturing devices 10 connects with one video server 12 via a Bayonet Neill Concelman (BNC) 11, and each video server 12 connects with one storage system 14. In the embodiment, each storage system 14 can be installed in the video server 12 or be externally connected with the video server 12. The video server 12 is configured for receiving the video data captured by the video capturing devices 10 via the BNC 11, storing the video data to the corresponding storage system 14 and sending the video data to the network switch 20 simultaneously.

The network switch 20 transmits the video data to the reverse network switch 22 via a communication link 21. The reverse network switch 22 is configured for sending the video data to the NVR 30 for storing. In the illustrated embodiment, the network switch 20 is an access layer switch, and the reverse network switch 22 is a distribution layer switch. Both of the network switch 20 and the reverse network switch 22 include several ports, each of the several ports of the network switch 20 connects with each of the at least one video server 12, and each of the several ports of the reverse network switch 22 connects with each of the at least one NVR 30.

A total number of the at least one NVR 30 needed to store the video data may be determined by the storage capacity of the NVR 30, a storage length of the video data, and a total number of the at least one video capturing device 10. For example, if the local monitoring sub-system 1 includes ten video capturing devices 10, the NVR 30 has a large storage capacity, and the storage length of the video data is only 120 hours, the total number of the at least one NVR 30 may be one or two, for example. The present embodiment gives an example that the total number of the at least one NVR 30 equals the total number of the video capturing devices 10. Namely, each of the video capturing devices 10 corresponds to one NVR 30.

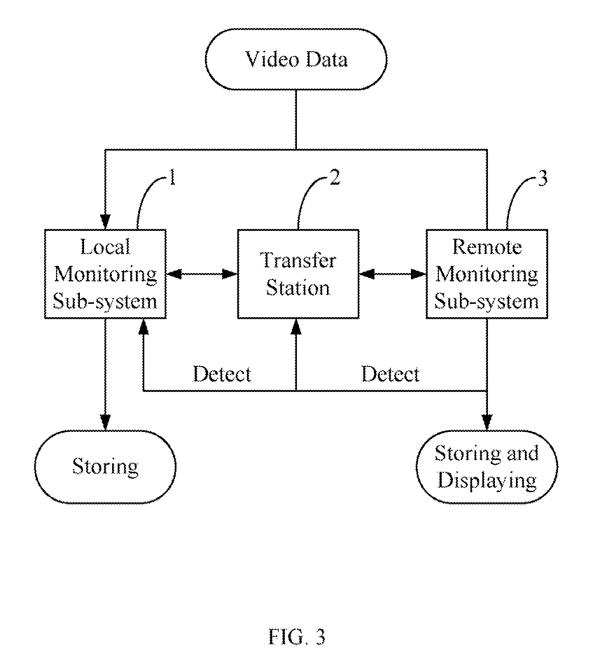

The video management computer 34 connects with the reverse network switch 22, and is configured for reading the video data from the NVR 30, and displaying the video data as one video picture on the corresponding monitor 36 (only one monitor 36 is shown in FIG. 2). See in FIG. 3, which is a signal flowchart of one embodiment of the video data. In the embodiment, a total number of the at least one monitor 36 may be determined by the total number of the video capturing devices 10.

The monitoring computer 32 connects with the reverse network switch 22, and is configured for detecting whether the video data has any abnormalities, and recording a start time of the abnormity if the video data has any abnormalities. In the embodiment, the abnormity may be defined as video data showing someone prowling around among the local monitoring sub-system 1.

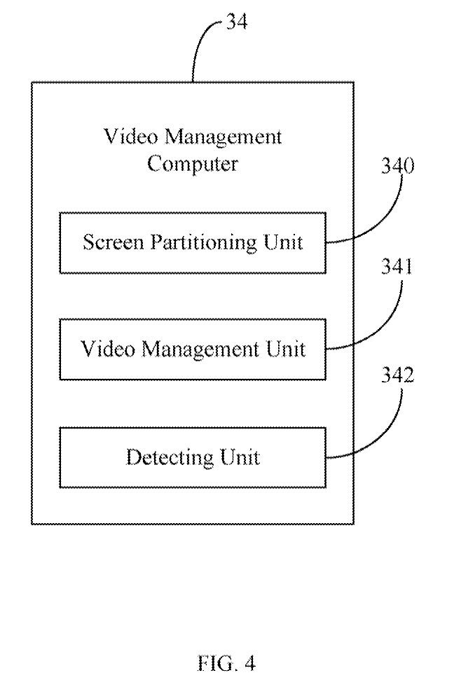

FIG. 4 is a block diagram of one embodiment of the video management computer 34 in FIG. 2. In the embodiment, the video management computer 34 includes a screen partitioning unit 340, a video management unit 341, and a detecting unit 342.

The screen partitioning unit 340 is configured for generating a first parameter for controlling the video data captured from each of the video capturing devices 10 to store in a designated NVR 30, setting a total number of video pictures displayed on each of the at least one monitor 36 simultaneously, partitioning a screen of each of the at least one monitor 36 to several sections according to the total number of the video pictures, and generating a second parameter for controlling the video data to display the video data on a designated monitor 36.

The video management unit 341 is configured for reading the video data from the designated NVR 30, and displaying one video picture based upon the video data on the designated monitor 36 according to the second parameter.

The detecting unit 342 is configured for generating an alarm signal if the monitor 36 does not display any video picture, and generating a detecting command to detect whether a fault occurs on the video monitoring system. For example, the detecting unit 342 detects the reverse network switch 22, the communication link 21, the network switch 20, the video server 12, the BNC 11, and the video capturing device 10 according to the detecting command, and determines which hardware of the video monitoring system is faulty (e.g., does not work), for example, the detecting unit 342 detects if any of the hardware does not respond to display the video picture.

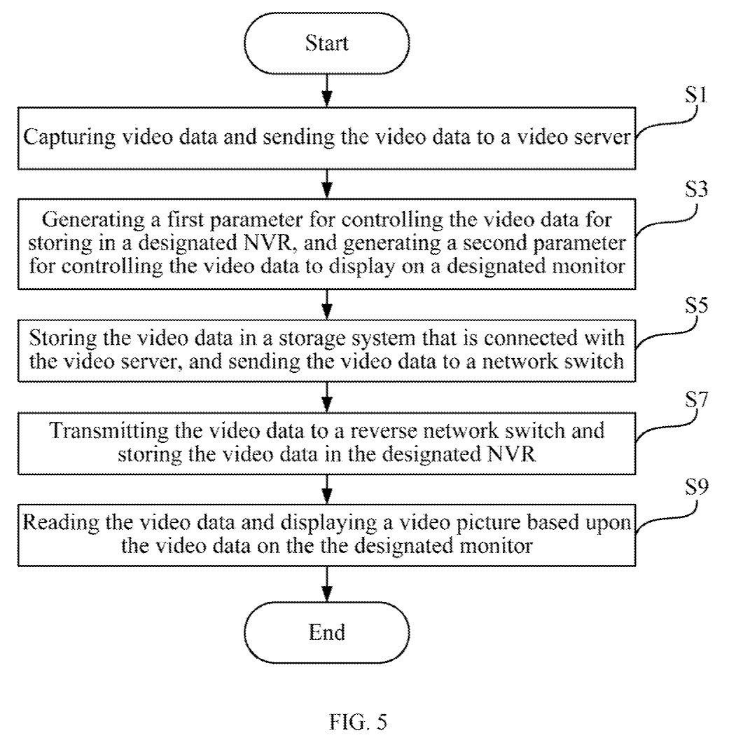

FIG. 5 is a flowchart of one embodiment of a video monitoring method by implementing the video monitoring system of FIG. 1 as described above. Depending on the embodiment, additional blocks may be added, others removed, and the ordering of the blocks may be changed.

In block S1, each of the video capturing devices 10 captures video data from the local monitoring sub-system 1, and sends the video data to the video server 12 via the corresponding BNC 11.

In block S3, the screen partitioning unit 340 of the video management computer 34 generates a first parameter for controlling the video data to store in a designated NVR 30, and generates a second parameter for controlling the video data to display on a designated monitor 36. The screen partitioning unit 340 further sets a total number of video pictures displayed on each of the at least one monitor 36 simultaneously.

In block S5, the video server 12 receives the video data, stores the video data in a corresponding storage system 14 that is connected with the video server 12, and sends the video data to the network switch 20.

In block S7, the network switch 20 transmits the video data to the reverse network switch 22, and stores the video data in the designated NVR 30 according to the first parameter set in block S1. During the time that the video data is stored in the designated NVR 30, the monitoring computer 32 may detect whether the video data has any abnormalities and record a start time of the abnormity if the video data has any abnormalities.

In block S9, the video management unit 341 of the video management computer 34 reads the video data from the designated NVR 30, and displays a video picture based upon the video data on the designated monitor 36 according to the second parameter.

In another embodiment, if the designated monitor 36 does not display any video picture, the detecting unit 342 may generate a detecting command to detect whether the fault occurs on the local monitoring sub-system 1, the transfer station 2 and the remote monitoring sub-system 3 of the video monitoring system.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A video monitoring system, comprising:
at least one video capturing device for capturing video data;
at least one video server, each of the at least one video server connected with the at least one video capturing device, and configured for receiving the video data captured by the at least one video capturing device, and storing the video data to a storage system; and
a video management computer connected with the at least one video server and at least one monitor, the video management computer comprising:
a screen partitioning unit configured for generating a first parameter for controlling the video data to store in a designated network video recorder (NVR), setting a total number of video pictures displayed on each of the at least one monitor simultaneously, partitioning a screen of each monitor to several parts according to the total number of the video pictures, and generating a second parameter for controlling the video data to display on a designated monitor; and
a video management unit configured for reading the video data from the designated NVR, and displaying one video picture based upon the video data on the designated monitor according to the second parameter;
wherein each of the at least one video server is further configured for sending the video data to the designated NVR for storing according to the first parameter.

2. The video monitoring system of claim 1, wherein the video management computer further comprises a detecting unit configured for generating an alarm signal if the designated monitor does not display any video picture, and generating a detecting command to detect whether a fault occurs in the video monitoring system.

3. The video monitoring system of claim 1, further comprising a video monitoring computer configured for detecting whether the video data has any abnormalities, and recording a start time of the abnormity if the video data has any abnormalities.

4. The video monitoring system of claim 1, wherein the total number of the video pictures is equal to a total number of the at least one video capturing device.

5. The video monitoring system of claim 1, wherein the storage system is installed in the video server.

6. The video monitoring system of claim 1, wherein the storage system is externally connected with the video server.

7. A video monitoring method, comprising:
capturing video data via a video capturing device, and sending the video data to a video server;
generating a first parameter for controlling the video data for storing in a designated network video recorder (NVR), and a second parameter for controlling the video data to display on a designated monitor;
storing the video data in a storage system that is connected with the video server;
sending the video data to the designated NVR for storing according to the first parameter; and
reading the video data from the designated NVR and displaying one video picture based upon the video data on the designated monitor according to the second parameter.

8. The video monitoring method of claim 7, further comprising:
setting a total number of video pictures displayed on the designated monitor simultaneously.

9. The video monitoring method of claim 8, further comprising:
partitioning a screen of the designated monitor to several parts according to the total number of the video pictures.

10. The video monitoring method of claim 7, further comprising:
sending the video data to a video monitoring computer;
detecting whether the video data has any abnormalities; and
recording a start time of the abnormity if the video data has any abnormalities.

11. The video monitoring method of claim 7, further comprising:
generating an alarm signal if the designated monitor does not display any video picture; and
generating a detecting command to detect whether a fault occurs.

12. A video monitoring method comprising:
capturing video data via a video capturing device and sending the video data to a video server;
storing the video data in a storage system that is connected with the video server, and sending the video data to a network video recorder (NVR) for storing; and
reading the video data and displaying a video picture based upon the video data on a monitor.

13. The method of claim 12, further comprising:
sending the video data to a video monitoring computer;
detecting whether the video data has any abnormalities; and
recording a start time of the abnormity if the video data has any abnormalities.

14. The method of claim 12, further comprising:
generating an alarm signal if the monitor does not display any video picture; and
generating a detecting command to detect whether a fault occurs.
